(19) United States
(12) Patent Application Publication
(10) Pub. No.: US 2014/0181121 A1
(43) Pub. Date: Jun. 26, 2014

(54) FEATURE EMBEDDING IN MATRIX FACTORIZATION

(71) Applicant: MICROSOFT CORPORATION, Redmond, WA (US)

(72) Inventors: NIR NICE, KFAR VERADIM (IL); NOAM KOENIGSTEIN, RAANANA (IL); ULRICH PAQUET, CAMBRIDGE (GB); SHAHAR ZVI KEREN, HEMED (IL); ANDREW JAFFRAY, SEATTLE, WA (US)

(73) Assignee: MICROSOFT CORPORATION, REDMOND, WA (US)

(21) Appl. No.: 13/723,539

(22) Filed: Dec. 21, 2012

(51) Int. Cl. G06F 17/30

(52) U.S. Cl. CPC G06F 17/3064
USPC 707/748; 707/767

(57) ABSTRACT

In various embodiments, systems and methods are provided for enhancing media content recommendations by using feature vectors. An enhanced-matrix having a first portion and a second portion is received. The first portion of the enhanced-matrix includes a user-item matrix and the second portion of the enhanced-matrix includes a feature-item matrix. Each entry in the feature-item matrix is item metadata. An item-stem vector is determined based on a weighted sum of each of the feature vectors associated with the item. An item-latent-trait vector is generated based on the item-stem vector and an item-offset vector. The item-offset vector is an item vector for the item in the user-item matrix. One or more recommended-media content derived based on the item-latent-trait vector is provided.

### BACKGROUND

Recommendation systems help predict user interest in products or services. Recommendation systems have become extremely common in a variety of media services including media delivery services. Recommendation systems may use several different approaches to provide recommendations to users.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention are provided for enhancing media content recommendations by using feature vectors. A user-item matrix may be enhanced with two individual stand-alone matrices, a feature-matrix of a user and/or an item such that matrix factorization generates a latent space model used to inform relationships between user and items. A user-item matrix includes entries that are signals that represent feedback from a user on particular items. In the feature-matrices, each user or item is associated with a plurality of features that represent metadata for that particular user or item. Every user and item in the user-item matrix has a prior probability distribution (hereinafter “prior”). The prior for a user or an item is based on the sum of the features of the user or the sum of the features of the item in a respective feature matrix. In embodiments, the sum of the features may be a weighted sum. The prior represents a probability value for the user or item within the user-item matrix. The prior based on the sum of the features is called the stem. In this regard, each user or item may be associated with a user-stem vector or item-stem vector calculated based on a sum of each of the feature vectors associated with the user or item. Further, each user or item may also deviate from the stem based on information associated with the user or item. The user or item vector difference or deviation from the stem is called the offset. The user or item stem and offset may be used to develop the latent space model with latent-trait vectors for users and items used in identifying and then providing recommended-media content.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system architecture in which embodiments of the invention may be employed;

FIGS. 3A-3C are a depiction of an exemplary enhanced-matrices and latent space models showing a method for enhancing media content recommendations by using feature vectors with an embodiment of the present invention;

FIGS. 4A-4C are graphs showing a method for enhancing media content recommendations by using feature vectors with an embodiment of the present invention;

FIG. 5 is a flow diagram a method for enhancing media content recommendations by using feature vectors with an embodiment of the present invention;

FIG. 6 is a flow diagram showing a method for enhancing media content recommendations by using feature vectors with an embodiment of the present invention; and

FIG. 7 is a flow diagram showing a method for enhancing media content recommendations by using feature vectors with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are provided for enhancing media content recommendations by using feature vectors. A recommendation system evaluates user interests and performs calculations using user-interest data to identify recommended-media content. For example, when users watch movies, they may provide feedback on their level of satisfaction with each movie. User satisfaction information for movies may be collected and the data used to make recommendations to other users. In operation, matrix factorization provides a way for recommendation systems to recommend media content. In particular, collaborative filtering in matrix factorization creates a user-item matrix for recommending different types of media (e.g., movies, music, video games, television shows). The user-item matrix is used to analyze associations between users and items to make new associations between other users and items. For example, an n-dimensional user-item matrix may include rows representing users and columns representing items. The matrix may include signals that are ratings or preferences for items. The ratings or preferences may be associated with either a particular user or device. A rating system of “Like” and “Does-not-Like” may exist as entries in matrix cells. In embodiments, a question mark may represent the case where a user has not yet rated an item. Each user may have rated one or more items in the system and a recommendation or prediction is made for one or more items that the user has not yet used. Matrix factorization with collaborative filtering, however, suffers from cold users or cold items, that is, users or items without sufficient usage information. Users and items without sufficient information may not be properly modeled for making new associations to provide recommendations. In particular, with respect to latent space models that mathematically generate additional realized relationships between users and items, it is difficult to explain the intuitive meaning for the direction of vectors in the latent space. As such, embodiments in the present invention provide methods and systems for identifying recommended-media content based on matrix factorization that models a latent space using feature vectors of users and items.

Embodiments of the present invention are provided for enhancing media content recommendations by using feature vectors. A user-item matrix may be enhanced with at least one stand-alone feature-matrix of a user and/or an item such that matrix factorization generates a latent space model used to inform relationships between user and items. A user-item matrix includes entries that are signals that represent feedback from a user on particular items. In the feature-matrices, each user or item is associated with a plurality of features that represent metadata for that particular user or item. Every user and item in the user-item matrix has a prior probability distribution (hereinafter “prior”). The prior for a user or an item vector is based on the sum of the features of the user or the sum of the features of the item in a respective feature matrix. It is contemplated within the scope of the present invention that the sum of the features may be a weighted sum, such that different individual features may be more or less influential. The prior represents a probability value for the user or item within the user-item matrix. The prior based on the sum of the features is called the stem. In this regard, each user or item may be associated with a user-stem vector or item-stem vector calculated based on a sum of each (e.g., pure sum, weighted sum, or normalized sum) of the feature vectors associated with the user or item. Further, each user or item may also deviate from the stem based on information associated with the user or item. The user or item vector difference or deviation from the stem is called the offset. The user or item stem and offset may be used to develop the latent space model with latent-trait vectors for users and items used in identifying recommended-media content and then providing for display the recommended-media content.

In embodiments, the features are also used to achieve a latent representation of cold users or cold items without sufficient information in the user-item matrix. Such users or items may be represented in the latent space by a user-stem vector or item-stem vector derived from the feature-matrix. As such, even if a user or item does not have sufficient information to develop an offset vector in the user-item matrix, the user or item will still be represented in the latent space. In addition, user replacement or item replacement may be used to more accurately represent the user or item vectors in the latent space. Users and items not properly represented in the latent space may be replaced. As will be discussed in more detail below, “Cold” is a designation for users or items without sufficient information (e.g., ratings) from which to draw inferences about similar user or items from which to make recommendations. In contrast, “warm” is designation for users or items with sufficient information. In embodiments, “warm” users or items may provide information from which to draw inferences about similar users or items in order to identify recommended-media content. Warm users or items have sufficient information and are properly represented within the latent space. In operation, a subset of warm users or warm items similar to a cold user or cold item respectively are identified and the cold user or cold item associated with the subset is replaced or repositioned based on a vector value derived from the subset.

In a first aspect of the present invention, computer storage media having computer-executable instructions that, when used by one or more computing devices, cause the one or more computing devices to perform a method for enhancing media content recommendations by using feature vectors. The method includes receiving an enhanced-matrix having a first portion and a second portion. The first portion includes a user-item matrix and the second portion includes a feature-item matrix. Each entry in the feature-item matrix is item metadata. The method also includes determining an item-stem vector based on a sum of each of the feature vectors associated with the item. The method further includes generating an item-latent-trait vector based on the item-stem vector and an item-offset vector. The item-offset vector is an item vector for the item in the user-item matrix. The method also includes providing one or more recommended-media content identified based on the item-latent-trait vector.

In a second aspect of the present invention, computer storage media having computer-executable instructions that, when used by one or more computing devices, cause the one or more computing devices to perform a method for enhancing media content recommendations by using feature vectors. The method includes accessing a latent space model. The latent space model is associated with an enhanced-matrix. The method also includes identifying in the latent space model a cold item vector with a threshold amount of information in the enhanced-matrix. The method further includes selecting a subset of warm items with a threshold amount of information. Each warm item in the subset of items is similar to the cold item based on features associated with the cold item. The method also includes repositioning the cold item within the latent space model based on a vector value derived from the subset of warm items. The method further includes identifying one or more recommended-media content based on the latent space model having the cold item.

In a third aspect of the present invention, a method for enhancing media content recommendations by using feature vectors is provided. The method includes receiving a plurality of signals. The plurality of signals represents feedback for media content. The method further includes receiving a plurality of users and items. Each user is associated with a plurality of features having user-metadata and each item is associated with a plurality of features having item-metadata. The method also includes generating an enhanced-matrix having a first portion and a second portion. The first portion includes a user-item matrix and the second portion includes a feature-item matrix. The method further includes determining an item-stem vector based on a sum of each feature vector associated with the item. The method also includes generating an item-latent-trait vector based on the item-stem vector and an item-offset vector. The item-offset vector is an item vector for the item in the user-item matrix. The method further includes providing one or more recommended-media content identified based on the item-latent-trait vector.

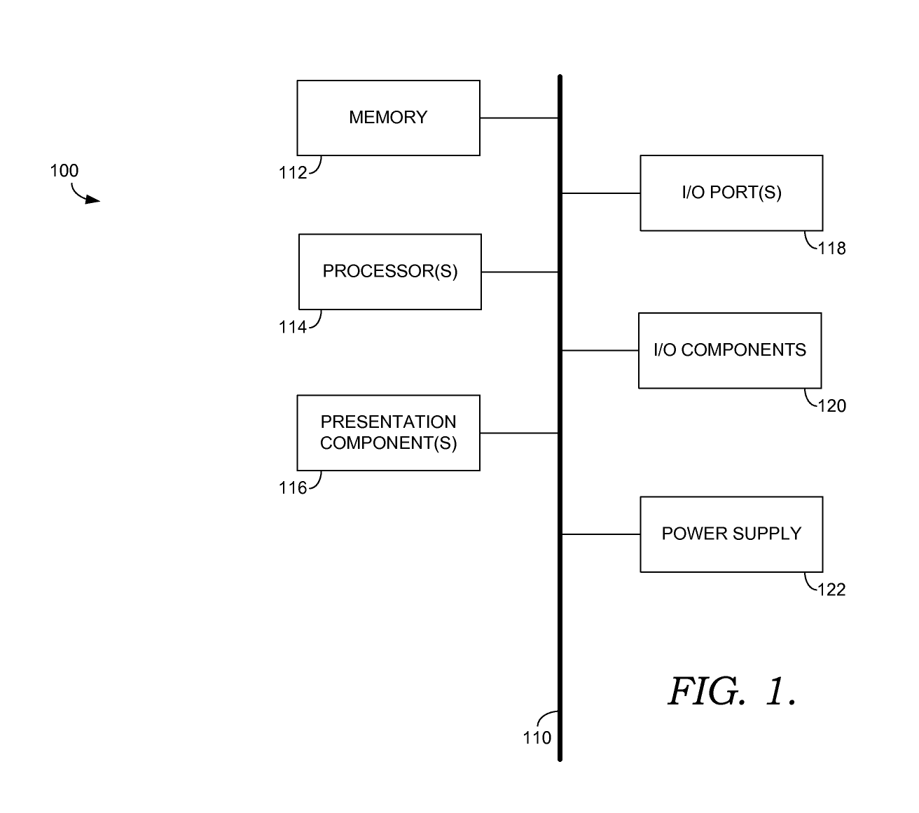

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. The invention may be practiced in a variety of system configurations, including handheld devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computing device.”

Computing device 100 typically includes a variety of computer-readable media. Computer-readable media can be any available media that can be accessed by computing device 100 and include both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media excludes signal per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

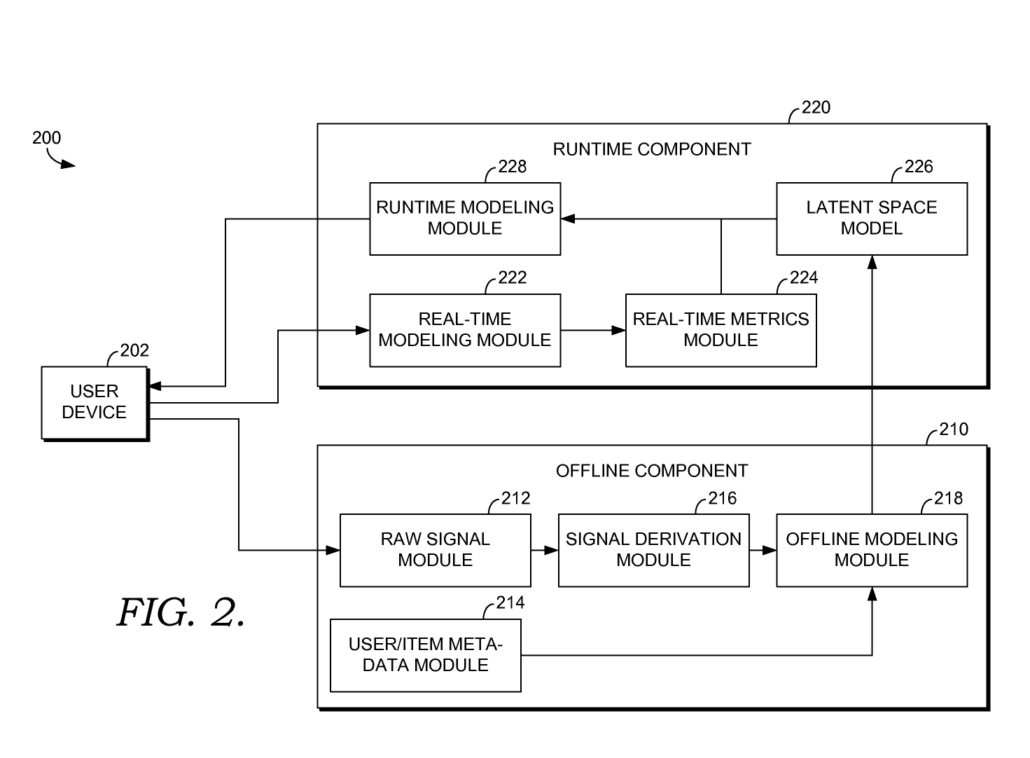

With additional reference to FIG. 2 a block diagram depicting an exemplary network environment 200 suitable for use in embodiments of the invention described. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Turning now to FIG. 2, an exemplary computing system architecture 200 suitable for identifying recommended media content is provided, in accordance with an embodiment of the present invention. The computing system architecture 200 shown in FIG. 2 is an example of one suitable computing system architecture 200. The computing system architecture 200 comprises multiple computing devices similar to the computing device 100 described with reference to FIG. 1. The computing system architecture 200 should not be interpreted as having any dependency or requirement related to any single module/component or combination of modules/components illustrated therein. Each may comprise a single device or multiple devices cooperating in a distributed environment. For instance, components may comprise multiple devices arranged in a distributed environment that collectively provide the functionality described herein. Additionally, other components not shown may also be included within the network environment.

The computing system architecture 200 includes a user device 202, an offline component 210, and a runtime component 220. The offline component 210 includes a raw signal module 212, a user/item metadata module 214, a signal derivation module 216, and an offline modeling module 218. The runtime component 220 includes a real-time modeling module 222, a real-time metrics module 224, a latent space model 226, and a runtime modeling module 228. At a high level, the offline component 210 and the runtime component 220 help provide recommended-media content based on feature vectors. The offline component 210 performs offline modeling of user signals used in developing a latent space model 226. The offline component 210 receives raw signals at the raw signal module 212. The signals may be associated with a user or device. At the signal derivation module 216, the raw signals are used to derive reformed-signals. The offline modeling module 218 receives user and item metadata from the user-item metadata module to model the user-item space. In embodiments, the user and item metadata may be received or supplemented by an external source of metadata information. The offline modeling module 218 processes and forwards the offline model into the latent space model 226 in the runtime component 220 after matrix factorization, such that results may be generated during runtime at runtime component 220. It is contemplated that the offline component 210 may also identify and communicate recommended-media content independently of the runtime component 220 based on a latent space model 226.

The runtime component 220 identifies recommended-media content based on the latent space model 226 and real-time metrics. The runtime component 220 receives real-time signals from the real-time modeling module 222. The real-time signals are processed to identify real-time metrics at the real-time metrics module 224. The real-time metrics module 224 may adjust the latent space model 226 based on the real-time metrics derived from the real-time signals. The runtime modeling module 228 computes new relationships based on the real-time metrics to identify recommended-media content at runtime. The runtime modeling forwards the recommended media to a user device 202. Recommended-media content may include targeted media. For example, people who use social networks store various information associated with different social networks including but not limited to age, gender, interests, and location. The stored information may be used to identify recommended-media content targeted at that particular user group or social network. Advertising media for a particular user or device may also be included such that mostly advertisements that actually interest the user are presented. Further, recommended-media may also include matchmaking media. Media may be identified based on matchmaking technique where similar users or similar devices are matched together. For example, a gamer may be matched with another gamer for the purpose of identifying media content from both users and generating recommendations based on each other.

With continued reference to FIG. 2, the raw signal module 212 processes every signal from which some estimation of user-item, item-item, or user-user relationship may be derived. The raw signals module drives signal collection such that as many indications as possible for users or items may be collected for usage, purchase, rating, search queries, click-through, etc. By way of illustration, a signal may be a feedback signal that measures a level of interest. A signal may be associated with a particular user or device. A signal may be any type of information received from a user that is associated with a type of media. In an embodiment, a user may submit a Like or Not Like feedback for a purchase or usage of a product. In another embodiment, the signal could be a multiple rating system (e.g., a 1-5 star rating). The signal may describe how a user feels about particular media content. In such embodiments, the signal may describe how pleased or dissatisfied the user is with the media content. Media content, for example, may include movies, music, video games, television shows, advertisements and other types of multimedia content or content that may be accessed via the user device 202. The raw signals are received from the user device 202 processed and forwarded to the signal derivation module 216 for additional processing. In embodiments, the input signals may be associated with auxiliary descriptors (e.g., metadata) that provide additional information for the input signal. For example, an input signal may include time of day or geographic location of the device from which the input signal is received.

The user/item metadata module 214 manages user and item associations with a plurality of metadata. Users and items are enriched with metadata. For example, metadata may include descriptive information used to search, identify, and locate different types of users and items. User metadata may include demographic information (e.g., age, sex/gender, race, income, education level.) and item metadata may include item information (e.g., genre, actor, director, release-date, and rating). The user or item metadata may be identified or generated within the offline component 210. In embodiments, the user or item metadata is received or supplemented via an external feed. For example, a movie catalog database may provide movie items and metadata associated with the movies. The user and item metadata is used during modeling to help characterize users and items. “Cold” is a designation for users or items without sufficient information (e.g., ratings) from which to draw inferences about similar user or items from which to make recommendations. Typically, the recommendation system constructs a latent space model 226 based on information associated with a user or item; however, when sufficient information does not exist, this creates a cold start problem where the system cannot provide intelligent recommendations. In contrast, “warm” is designation for users or items with sufficient information. In embodiments, “warm” users or items may provide information from which to draw inferences about similar users or items in order to identify recommended-media content. In this regard, metadata will have less of an effect on warm users and warm items and more of an effect on cold users and cold items.

As will be discussed in detail below, the metadata associations of the users and items may be used to provide information for cold users and cold items based on warm users and warm items, even when such information is not available for cold users or cold items. The distinction between cold and warm may not be a binary distinction. Some users or items are defiantly cold, for example, users or items with no information at all, while some users or items are defiantly warm, for example, the most active users and most popular games. It is possible to have a range where a user or an item is neither warm nor cold. In this regard, some users or items may still be difficult to model if their interactions are mostly with less informative users or items. For example, if a user watched a very popular movie, it may be less informative because the data associated with the movie item suggests that everyone like the movie. Conversely, items that are watched by users with very distinct taste are easier to model and require less feedback examples than other items.

The value of a particular feature may also differ in that it may be informative or uninformative. Further, like warm/cold labels, the distinction between the features is not necessarily binary. An informative feature may be a feature associated with particular metadata that informs the preference or the ranking of an item based on the feature. For example, a movie is an animated movie or a horror movie, and as such a specific audience for these types of movies exists because of that feature. In contrast, an uninformative feature is associated with a particular metadata that does not provide information about the preference or the ranking of the item based on the feature. For example, a movie that is filmed in the USA, because it may be too broad and there are too many movies that were filmed in the USA, that feature is not as informative. As such features may be weighted according to the informative value associated with the feature.

The signal derivation module 216 converts the raw signal information into a reformed-signal. The reformed-signal provides a particular way of storing and organizing the signal data such that it may be used efficiently. At a basic level, the signal derivation module 216 receives the user feedback information as raw signal information and converts the raw signal information into a reformed-signal that may used in matrix factorization. It is contemplated that different types of reformed-signals may be utilized for the present invention. In one embodiment, all signal data is converted into “Like” and “Does-not-Like” transactions. The reformed-signal data may be text or numeric data. The signal derivation module 216 then forwards the reformed-signal to the offline modeling module 218.

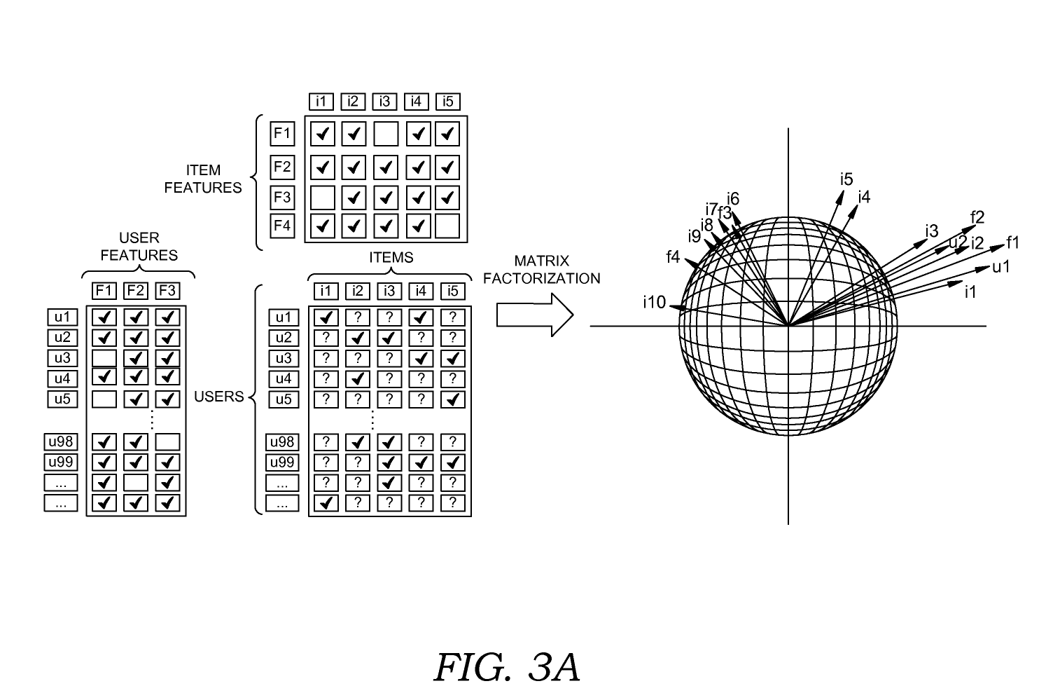

The offline modeling module 218 generates matrices and performs factorization on matrices such that a latent space model 226 is generated. In one embodiment, the offline modeling module 218 matrices are sparse matrices. The offline modeling module 218 may use convergence logic or same logic in factorizing matrices. Convergence logic may be used when offline modeling module 218 factorizes two or more individual stand-alone matrices as shown in FIG. 3A. While, same logic factorization may be used when factorizing a single concatenated matrix as shown in FIG. 3B. Factorization allows for user and item modeling in a latent space. The process of user and item modeling is a combined data-analysis and machine learning process, during which a variety of signals (users-items transactions, search queries, users' activities and users/items metadata) may be analyzed to identify relationships between users and items. The output of the modeling process is a canonical representation of users and items inside a multidimensional space called “latent space” that enables understanding the derived relationships. In operation, the offline module receives the derived signal from the signal derivation module 216. The offline modeling module 218 also receives the user and items metadata. It is contemplated that several different embodiments may be used in generating matrices and factorization, thus the exemplary embodiment presented herein is merely illustrative. In one such embodiment, the offline modeling module 218 may generate a classic matrix with users and items. The offline module may also generate an enhanced-matrix. The enhanced-matrix is a data structure that comprises the classic matrix and also the set of features for each user or item in individual matrices. In embodiments, the user-item matrix is designated as a first portion, the feature-item matrix is designated as a second portion, and the user-feature matrix is designated as a third portion.

As seen in FIG. 3A, the enhanced-matrix includes an item features portion and a user features portion. It is contemplated that the user-item matrix may include each portion individually or both at the same time for processing. Factorization of the matrix in FIG. 3A may be by convergence logic. The user and items are each annotated with a plurality of features, as designated by a check mark in FIG. 3. In embodiments, the features are taken from a closed set of features. By way of illustration, a set of features for a movie may include <Not Serious, Semi Serious, Serious, Boys' Night, Date Night, Family Outing, Girls' Night . . . >. The relationship between the user and features or items and features is such that similar users or items have similar set of features. For example, a movie, m, may have a set of features denoted by Fₘ where the feature set may include: <Semi Serious, Boys' Night, Sports Movie, Boxing . . . >. Similarly, a user, n, may be associated with a set of features Fₙ, which may include <Female, Teenager, NYC . . . >.

In FIG. 3B, the enhanced-matrix is a single concatenated matrix including item features and user features. The matrix in FIG. 3B represents user and item metadata as additional collaborative information. For example, each item metadata is represented as a user, with an entry of 1 in for any items with said feature. Similarly, user metadata are represented as items, where the item entry in the matrix for all user that exhibit the metadata. In operation, for every item metadata, a new user is created. New collaborative data is added for the user that may designate a signal (e.g., Like) for all the items that exhibit the metadata. For example, for a movie genre (e.g., comedy), a new user “user-comedy” may be created and an entry of “1” for every item that is a comedy. Further, for every user metadata, a new item is created. New collaborative data for that item is added for the item that may designate a signal (e.g., Like) for all users that exhibit the metadata. For example, for an age group (e.g., 10-20) a new item “item-10-20” may be created and an entry of “1” for every user that is in the age group 10-20. A standard matrix factorization may be used, as the enhanced matrix looks like a classic collaborative matrix; however with the additional feature data information that generate additional results. In addition, the strength of influence of some metadata may be increased by representing the metadata with more than one user. The more users per metadata, the more the model are influenced by the metadata. In addition, this method also provides for metadata selection; where metadata identified as irrelevant or metadata that cause noise and distort the model may be deleted of have their influence lessened. Pre-processing a plurality of metadata may identify metadata that may be weighted to provide more influence in the matrix. It is contemplated that the matrix in FIG. 3B provides an alternative method for enhancing a matrix in accordance with embodiments of the present invention.

With reference now to FIG. 3A, matrix factorization within the matrix model in accordance with the present invention accounts for user features and/or item features. By way of illustration, in an embodiment with an enhanced-matrix with a user-item matrix and a feature-item matrix, each feature i is represented by a vector fᵢ. The feature i vector may be a latent-trait vector similar to the latent-trait vector for the item. Each user or item is represented by an “offset” vector, which has a prior based on the sum of its features (the “stem”). For example, for an item vector (offset) vₘ may be a function of:

$$p ( {v}_{m} ) = N ( {v}_{m} ; \frac{1}{\sqrt{\vert {F}_{m} \vert}} {\sum }_{{f}_{i} ∈ {F}_{m}} {f}_{i} ; {λ}^{- 1} I ) ,$$

where p(vₘ) is the prior distribution over the item offset vₘ defined by a normal distribution with a mean determined by the normalized sum of feature vectors

$$\frac{1}{\sqrt{\vert {F}_{m} \vert}} {\sum }_{{f}_{i} ∈ {F}_{m}} {f}_{i}$$

and a covariance matrix λ⁻¹I. The “stem” in this example, is the mean of the prior, namely

$$\frac{1}{\sqrt{\vert {F}_{m} \vert}} {\sum }_{{f}_{i} ∈ {F}_{m}} {f}_{i} .$$

As previously discussed, the sum of features may also be a weighted sum. The weighted sum may be based on the information value of a feature. Thus, the weighted sum of the feature vectors may be defined by Σ_{f}_{ᵢ}_{εF}_{ₘ}wᵢₘfᵢ where each feature vector has a weight multiplier wᵢₘ that factors in the information value of the feature. The weight may be collaboratively determined or the weighted may also be determined within the latent space model. The weight may be learned or based on predetermined values. In this regard, certain features may be weighted so they are in essence removed from the final result, while other features may be heavily weight to provide more influence to the results. With either formula, the prior based on the sum of the features may be used to identify “warm” users or items because collaborative information is shared across users or items with similar features. For example, information is shared by any movie that has the feature <Boxing> even if there are no common users who have watched both movies.

In addition, matrix factorization of the matrix model in accordance with embodiments provides for user or item replacement. Users and items that are not properly represented in the latent space may be replaced or repositioned in the latent space. User or item replacement or repositioning within the latent space contemplates updating one or more entries of an identified vector with one or more entries of a better positioned vector in the latent space. Users and items may be identified based on a number of different metrics (e.g., length of the vector or usage points). By way of illustration, the vector with a short length may signify a vector that is not properly represented in the latent space and a vector with a long length may signify a vector that is properly represented in the latent space. In embodiments, users or items associated with long vectors may be called warm users or warm items and the users or items associated with short vectors may be called cold users or cold items.

In operation, a subset of warm users or warm items may be identified based on a similarity measure to a cold user or cold item respectively. The similarity measure is defined based on a plurality of features, and calculates a number that determines how similar two users or items are to each other. For example, a similarity function s(i,j) between i and j may be defined using the Jaccard similarity as follows:

$$s ( i , j ) = \frac{\vert {F}_{i} ⋂ {F}_{j} \vert}{\vert {F}_{i} ⋃ {F}_{j} \vert} .$$

It is contemplated that several different similarity functions (e.g., cosine distance, hamming, or Euclidean distance) for determining a similarity between s(i,j) may be utilized in identifying a subset of warm users or warm items similar to cold users or cold items. The similarity function may also be weighted such that different features may influence the result differently. For example, a weighted Jaccard similarity function may be based on the norm of the feature vectors. Upon identifying a subset of warm items, a threshold similarity measure may be utilized to derive a vector value for the cold item. For example, using a similarity function, a top k vector may be identified as most similar to the user or item to be replaced or repositioned in the latent space. In one embodiment, the users or items are repositioned based on the average location of the top k vectors. In other embodiments, a median of the top k vectors may be calculated in order to reposition the users or item.

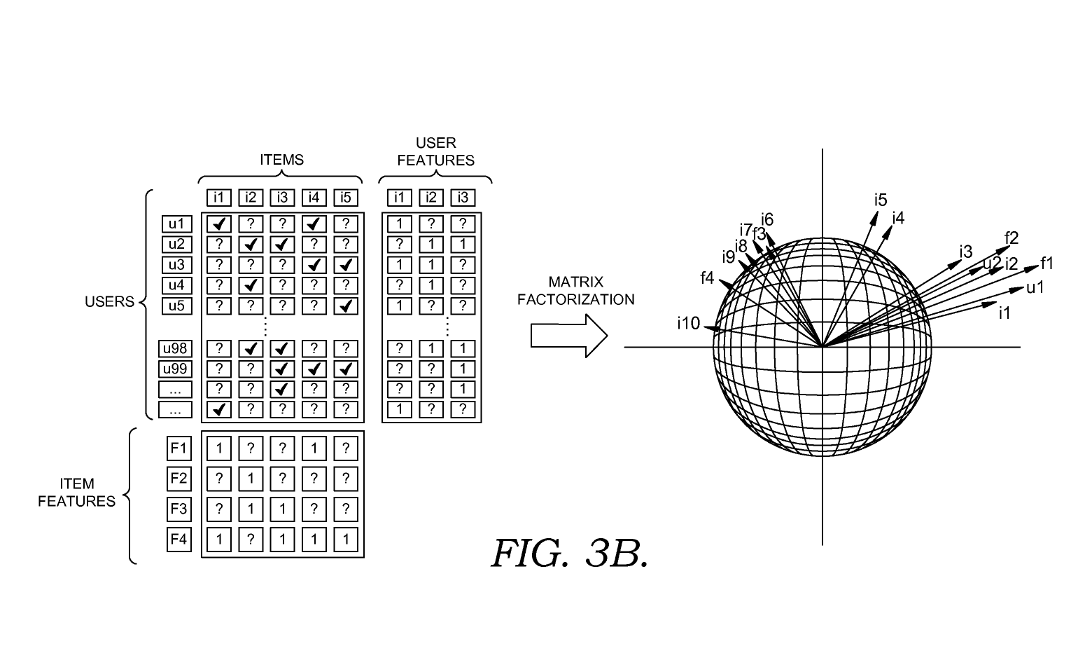

With continued reference to FIGS. 3A-3C and 4A-4C, matrix factorization generates a latent space model 226. FIG. 3C, for example, latent space features where an Action vector points generally in the same direction in the latent space as action movies Lethal Weapon and Die Hard, and a Fantasy vector points generally in the same direction in the latent space as fantasy movies Lord of the Rings, Harry Potter 2 and Harry Potter 3. By way of illustration for further explanation, an example will be presented below to describe the latent space model 226. In FIG. 4A several feature vectors <Serious, Semi Serious, Not Serious, Date Night and Boys'Night . . . > are graphically depicted in a two-dimensional space. Each movie with a subset of the above tags may be tagged accordingly—for example, <Not Serious, Boys' Night . . . >. Each tag may be embedded in an n-dimensional space. The sum of the features <Not Serious, Boy's Night . . . > calculates a stem or prior for any item vector associated with the features <Not Serious, Boy's Night . . . >. As shown in FIG. 4B, a vector represents movies with <Not Serious, Boy's Night . . . > tags. A movie, Rocky for example, and any other movie that has the <Not Serious, Boy's Night . . . > tags may have a prior or stem associated with the tags, as shown in FIG. 4C. In addition, because sufficient information is associated with Rocky, it creates an offset. In other words, the offset represents the difference or the deviation of Rocky from all the other movies that share the same <Not Serious, Boy's Night . . . > tags. Combining the offset and stem, generates a latent-trait vector for Rocky.

As shown in FIG. 2, the user and item metadata is used to generate the latent space model 226 that is a canonical representation of users and items inside a multidimensional space. The latent space model 226 may be used to inform relationships between users and items. In particular, embedding feature vectors in the latent space helps identify a plurality of different types of relationships between elements e.g., user-to-item, item-to-item, feature-to-item, user-to-user, item-to-user, feature-to-user, user-to-feature, item-to-feature, and feature-to-feature. Any variations and combinations thereof within the latent space are envisioned with the scope of the present invention. For example, the latent space model 226 may determine relationships between the users or items, and identify which items are more relevant to a specific user, which items that are mostly related to another item, which users have similar taste/usage-habits to a specific user (matchmaking), and which users are most interested in a specific item (targeting). The latent space model 226 maintains the latent space that may be used during offline process to make recommendation, however may also be used at runtime to provide recommended-media content for particular user experiences.

In operation, the real-time modeling module 222 provides rapid response to current signals to make a recommendation. For example, real-time modeling provides indications about the current session and current user intent. The real-time modeling module 222 operates with the real-time metrics (e.g., social scope, short-term intent, and content) to further refine the latent space model 226 to enable current and relevant modeling. For example, search query and click-through data may indicate a current user interest and context. A change in social scope (e.g., friends and user groups) may help derive social scope data that influence the current modeling. The recommended-media content are expanded by including social context to generate social based experience, by accounting for time and understanding time-based behavior, and by looking at the recent user's activities to adjust for the user's current (short term) intent.

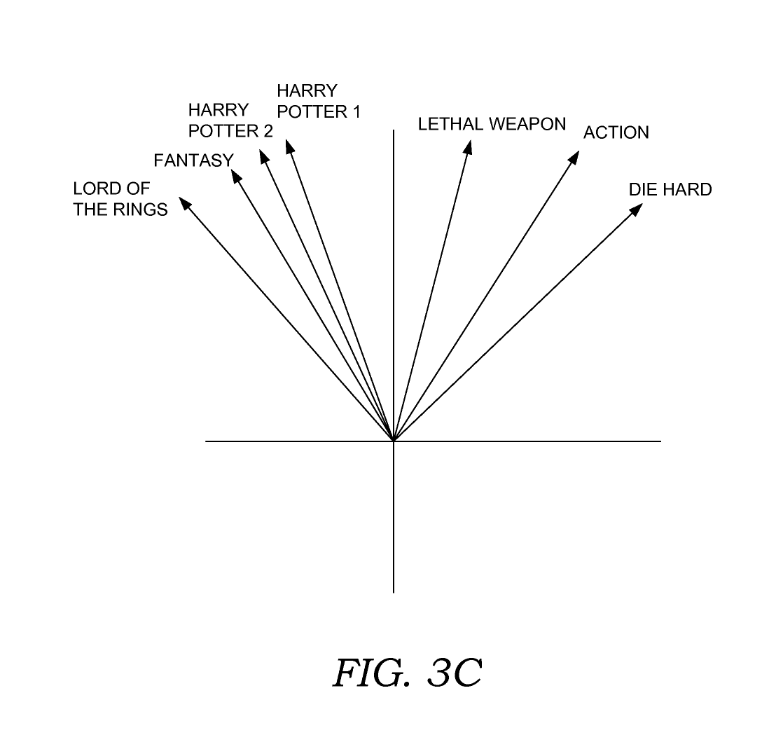

Turning now to FIG. 5, a flow diagram is provided that illustrates a method 500 for identifying recommended-media content. At block 510, an enhanced-matrix having a first portion and a second portion is received. The first portion includes a user-item matrix and the second portion includes a feature-item matrix. Each entry in the feature-item matrix is item metadata. The first portion of the enhanced-matrix includes entries that are signals that represent feedback from a user. The signals may be associated with a user or a user device. In embodiments, the enhanced-matrix further includes a third portion having a user-feature matrix. Each entry in the user-feature matrix is user metadata. At block 520, an item-stem vector is determined based on a sum of each of the feature vectors associated with the item. The item-stem vector is a prior probability distribution for the item that represents a probability value for the item within a matrix. An item-latent vector based on the item-stem vector and an item-offset vector is generated, as shown at block 530. The item-offset vector is an item-vector for the item in the user-matrix. At block 540, one or more recommended-media content identified based on the item-latent-trait vector are provided.

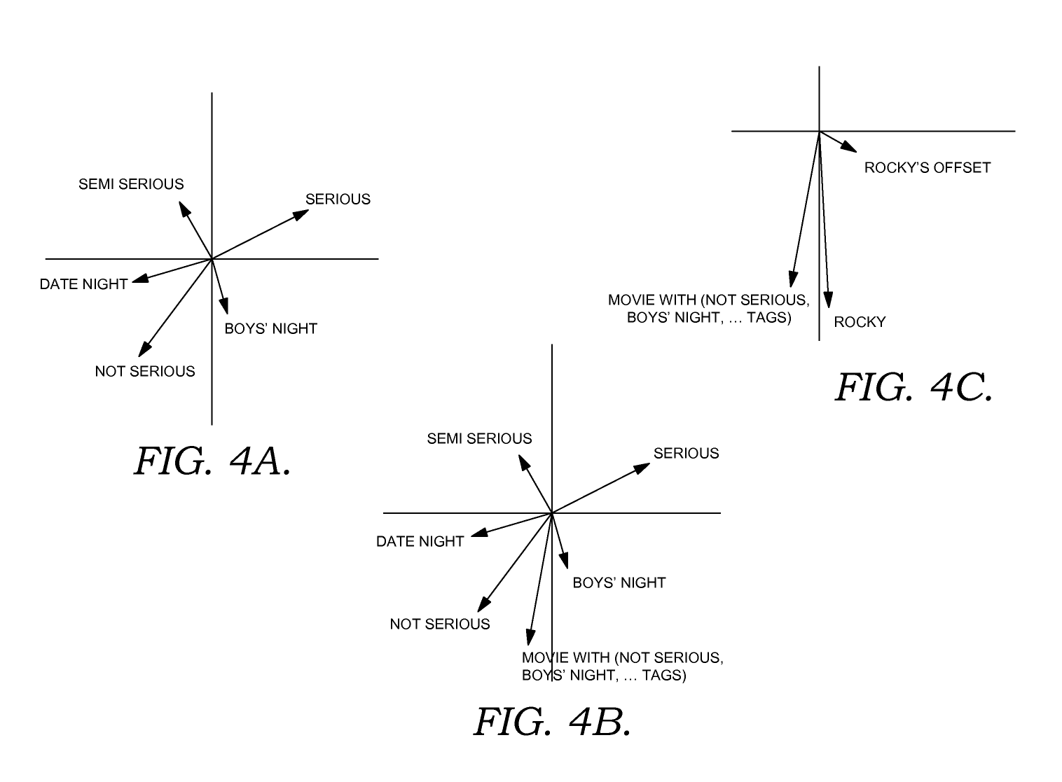

Turning now to FIG. 6, a flow diagram is provided that illustrates a method 600 for identifying recommended-media content. Initially, as shown at block 610, a latent space model is accessed. The latent space model is a canonical representation of users and items inside a multidimensional space that enables understanding the derived relationships between users and items. The latent space model is associated with an enhanced-matrix. The latent space model may include a plurality of latent-trait vectors based on a user-stem vector or an item-stem vector and a user-offset vector or an item-offset vector. As shown at block 620, a cold item vector with a threshold amount of information in the enhanced-matrix is identified in the latent space model. “Cold” is a designation for users or items without sufficient information (e.g., ratings) from which to draw inferences about similar user or items from which to make recommendations. Typically, the recommendation system constructs a latent space model based on information associated with a user or item; however, when sufficient information does not exist, this creates a cold start problem where the system cannot provide intelligent recommendations. “Warm” is designation for users or items with sufficient information, thus users or items may provide information from which to draw inferences about similar users or items in order to identify recommended-media content. At block 630, a subset of warm items with a threshold amount of information is selected. Each warm item in the subset of items is similar to the cold item based on features associated with the cold item. The cold item is replaced within the latent space based on a vector value derived from the subset of warm items, as shown at block 640. In embodiments, a threshold similarity measure for warm items may be utilized to derive a vector value for the cold item. For example, using a similarity function, a top k vector may be identified as most similar to the user or item to be replaced or repositioned in the latent space. In other embodiments, the users or items are repositioned based on the average location of the top k vectors. In addition, a median of the top k vectors may be calculated in order to reposition the users or item. At block 650, one or more recommended-media content is identified based on the latent space model having the cold item.

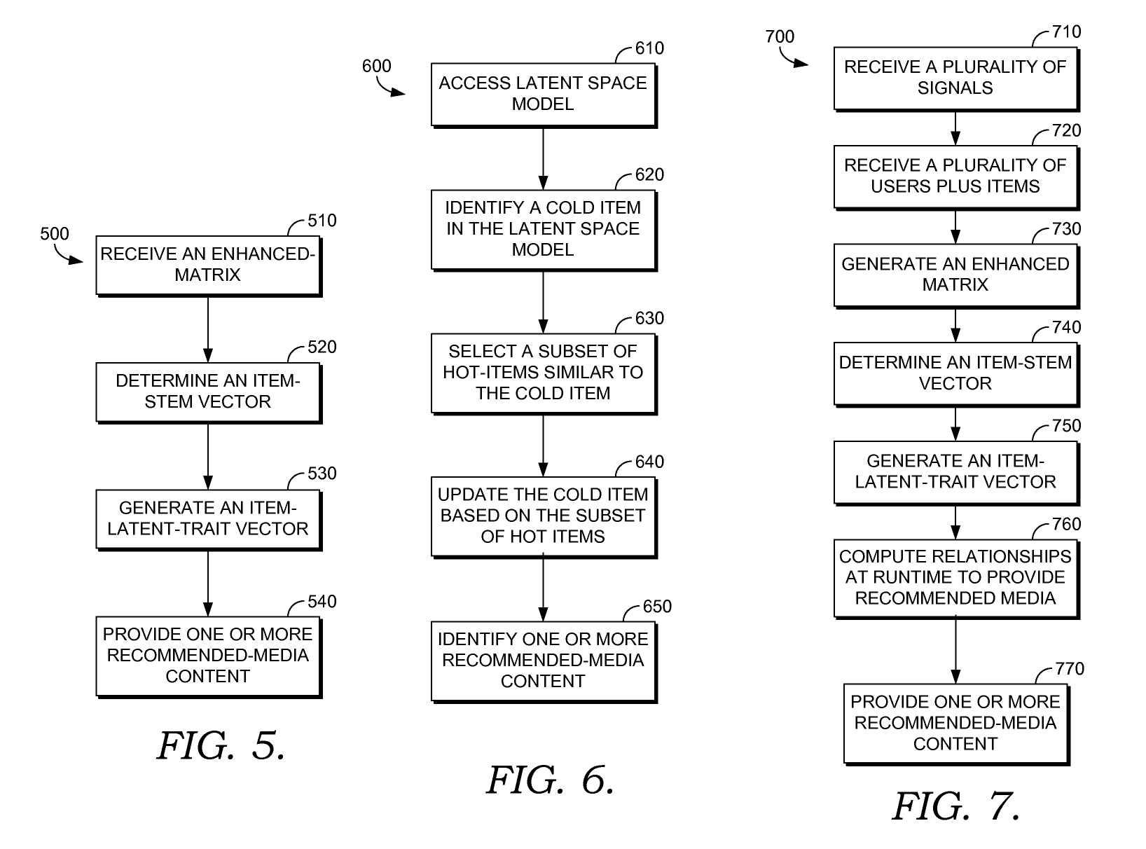

Turning now to FIG. 7, a flow diagram is provided that illustrates a method 700 for enhancing media content recommendations by using feature vectors. Initially, as shown at block 710, a plurality of signals is received. The plurality of signals represents feedback for media content. In embodiments, the plurality of signals may be reformed signals derived from raw signals that represent feedback from the user. After receiving the plurality of signals, a plurality of users and items is received, as shown at block 720. Each user is associated with a plurality of features having user-metadata and each item is associated with a plurality of features having item-metadata. At block 730, an enhanced-matrix having a first portion and a second portion is generated. The first portion of the enhanced matrix includes a user-item matrix and the second portion includes a feature-item matrix. At block 740, an item-stem vector based on a sum of each feature vector associated with the item is determined. The item-stem is the prior probability distribution (i.e. a probability value for the item within the user-item matrix.)

At block 750, an item-latent-trait vector based on the item-stem vector and an item-offset vector is generated. The item-offset vector is an item vector for the item in the user-item matrix. The item-offset vector represents the difference or the deviation of the item from all the movie items that share the same stem. For example, for movies, the stem may be a set of similar features associated that are associated with the movies. At block 760, relationships are computed at runtime to provide recommended-media content for the user device. At block 770 one or more recommended-media content identified based on the item-latent-trait vector are provided.

Embodiments of the present invention have been described in relation to particular embodiments that are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages that are obvious and inherent to the structure.

It will be understood that certain features and sub-combinations are of utility and may be employed without reference to other features or sub-combinations. This is contemplated by and is within the scope of the claims.

What is claimed is:

1. One or more computer storage media storing computer-useable instructions that, when used by one or more computing devices, cause the one or more computing devices to perform a method for enhancing media content recommendations by using feature vectors, the method comprising:
receiving an enhanced-matrix having a first portion and a second portion, wherein the first portion includes a user-item matrix and the second portion includes a feature-item matrix, and wherein each entry in the feature-item matrix is item metadata.
determining an item-stem vector based on a sum of each of the feature vectors associated with the item;
generating an item-latent-trait vector based on the item-stem vector and an item-offset vector, wherein the item-offset vector is an item vector for the item in the user-item matrix; and
providing one or more recommended-media content identified based on the item-latent-trait vector.

2. The media of claim 1, wherein the sum of each of the feature vectors associated with the item is calculated based on weighted sum function Σ_{f}_{ᵢ}_{εF}_{ₘ}wᵢₘfᵢ, wherein fᵢ is a feature-latent-trait vector, wᵢₘ is a weight multiplier, and Fₘ denotes the set of features of the item.

3. The media of claim 1, wherein the one or more recommended-media content are identified based on a similarity between latent-trait vectors.

4. The media of claim 1, further comprising
identifying a cold item with a threshold amount of information in the enhanced-matrix; and
repositioning the cold item based on a cold item-stem vector.

5. The media of claim 1, wherein the enhanced-matrix further comprises a third portion, wherein the third portion includes a user-feature matrix, and wherein each entry in the user-feature matrix is user metadata.

6. The media of claim 5, further comprising
determining a user-stem vector based on a sum of each of the feature vectors associated with the user; and
generating a user-latent-trait vector based on the user-stem vector and a user-offset vector, wherein the user-offset vector is a user vector of the user in the user-item matrix.

7. The media of claim 5, further comprising
identifying a cold user without a threshold amount of information in the enhanced-matrix; and
repositioning the cold user based on the cold user-stem vector.

8. The media of claim 5, wherein providing one or more recommended-media content identified is further based on at least one of the following identified relationships:
user-to-item, item-to-item, feature-to-item, user-to-user, item-to-user, feature-to-user, user-to-feature, item-to-feature, and feature-to-feature.

9. One or more computer storage media storing computer-useable instructions that, when used by one or more computing devices, cause the one or more computing devices to perform a method for enhancing media content recommendations by using feature vectors, the method comprising:
accessing a latent space model, wherein the latent space model is associated with an enhanced-matrix;
identifying, in the latent space model a cold item with a threshold amount of information in the enhanced-matrix;
selecting a subset of warm items with a threshold amount of information, wherein each warm item in the subset of warm items is similar to the cold item based on features associated with the cold item;
repositioning the cold item within the latent space model based on a vector value derived from the subset of warm items; and
identifying one or more recommended-media content based on the latent space model having the cold item.

10. The media of claim 9, wherein the latent space model comprises a plurality of latent trait vectors based on a stem vector and an offset vector.

11. The media of claim 9, wherein identifying in the latent space model the cold item with the threshold amount of information in the enhanced-matrix is based on an absolute value of the sum of the features associated with the cold item.

12. The media of claim 9, further comprising:
providing for display the one or more recommended-media content derived based on the cold item.

13. The media of claim 9, wherein the vector value derived from the subset of warm items is based on an average vector value for one or more warm items identified from the subset of warm items based on a threshold similarity.

14. The media of claim 9, wherein a similarity between each warm item in the subset of warm items and the cold item is based on a Jaccard similarity function.

15. The media of claim 9, further comprising
identifying in the latent space model a cold user with a threshold amount of information in the enhanced-matrix;
selecting a subset of warm users with a threshold amount of information, wherein each warm user in the subset of warm users is similar to the cold user based on the features associated with the cold user; and
repositioning the cold user within the latent space model based on a vector value derived from the subset of warm users.

16. A method for enhancing media content recommendations by using feature vectors, the method comprising:
receiving a plurality of signals, wherein the plurality of signals represent feedback for media content;
receiving a plurality of users and items, wherein each user is associated with a plurality of features having user-metadata and each item is associated with a plurality of features having item-metadata;
generating an enhanced-matrix having a first portion and a second portion, wherein the first portion includes a user-item matrix and the second portion includes a feature-item matrix;
determining an item-stem vector based on a sum of each feature vector associated with the item; and
generating an item-latent-trait vector based on the item-stem vector and an item-offset vector, wherein the item-offset vector is an item vector for the item in the user-item matrix; and
providing one or more recommended-media content identified based on the item-latent-trait vector.

17. The method of claim 16, wherein the plurality of signals is reformed signals derived from a plurality of raw signals that represent feedback from the user.

18. The method of claim 16, identifying recommended-media content further comprises:
receiving one or more real-time signals;
adjusting the item-latent-trait vector based on one or more real-time signals; and
computing one or more relationships at runtime for providing the recommended-media content.

19. The method of claim 16, wherein the one or more real-time signals include at least one of: a social scope, a short term intent, and a context.

20. The method of claim 16, wherein recommended-media content includes at least one of:
matchmaking media content; or
targeting media content.
